(19) United States
(12) Patent Application Publication
(10) Pub. No.: US 2016/0246029 A1
(43) Pub. Date: Aug. 25, 2016

(54) ACTUATOR AND CAMERA MODULE INCLUDING THE SAME

(71) Applicant: SAMSUNG ELECTRO-MECHANICS CO., LTD., Suwon-si (KR)

(72) Inventors: Yoo Chang KIM, Suwon-si (KR); Kyeong Jun KIM, Suwon-si (KR); Jung Seok LEE, Suwon-si (KR); Sung Hoon KIM, Suwon-si (KR); Man Su KIM, Suwon-si (KR); Jae Ho BAIK, Suwon-si (KR); Po Chul KIM, Suwon-si (KR); Myung Ki LEE, Suwon-si (KR)

(73) Assignee: SAMSUNG ELECTRO-MECHANICS CO., LTD., Suwon-si (KR)

(21) Appl. No.: 14/951,675

(22) Filed: Nov. 25, 2015

(30) Foreign Application Priority Data
Feb. 24, 2015 (KR) 10-2015-0025962

(51) Int. Cl. G02B 7/08; G02B 27/64

(52) U.S. Cl. CPC G02B 7/08; G02B 27/646

(57) ABSTRACT

An actuator and camera module having a carrier accommodating a lens portion; a magnet disposed on an outer circumferential surface of the carrier; a housing comprising an opening formed in an upper surface of the housing wherein lateral surfaces of the carrier and the magnet are disposed within the housing; a coil portion disposed on a lateral surface of the housing configured to face the magnet; a flexible printed circuit board comprising a terminal portion, formed on one surface of the flexible printed circuit board, configured to supply power to the coil portion, wherein the flexible printed circuit board is coupled to the housing; and a reinforcing portion protruding from a lower surface of the housing to support a rear surface of the terminal portion.

### CROSS-REFERENCE TO RELATED APPLICATION(S)

This application claims the benefit under 35 USC 119(a) of Korean Patent Application No. 10-2015-0025962 filed on Feb. 24, 2015, with the Korean Intellectual Property Office, the disclosure of which is incorporated herein by reference for all purposes.

### BACKGROUND

1. Field

The present disclosure relates to an actuator and a camera module including the same.

2. Description of Related Art

In general, a digital camera captures an image using an image sensor such as a charge coupled device (CCD) and a complementary metal-oxide semiconductor (CMOS) instead of film. A camera module for image capture has been used in various fields such as cameras for mobile devices with photographing functions, tablet personal computers (PC), and monitors or surveillance cameras installed in vehicles due to compact size and excellent performance. In particular, a camera module used in mobile devices has been gradually multi-functionalized, miniaturized, and lightened, in accordance with current trends.

A recent camera module used in mobile devices has auto focus and optical image stabilization (OIS), and devices included in a camera module are also required to meet miniaturization requirements by virtue of miniaturization of a lens and an increase in optical performance. Various examples of an actuator driving a camera module include voice coil motors (VCMs), step motors, piezoelectric actuators, micro electro mechanical systems (MEMS), and so on.

A voice coil motor (VCM) actuator used as an actuator of a camera module uses Lorentz force, that is, electromagnetic force generated between an electric field and a magnetic field.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes an actuator with a simplified structure in which a terminal portion of a flexible printed circuit board (PCB) may be prevented from being damaged by having a simple structure, without a structural change of the flexible PCB.

In another general aspect, an actuator and camera module having a carrier accommodating a lens portion; a magnet disposed on an outer circumferential surface of the carrier; a housing comprising an opening formed in an upper surface of the housing wherein lateral surfaces of the carrier and the magnet are disposed within the housing; a coil portion disposed on a lateral surface of the housing configured to face the magnet; a flexible printed circuit board comprising a terminal portion, formed on one surface of the flexible printed circuit board, configured to supply power to the coil portion, wherein the flexible printed circuit board is coupled to the housing; and a reinforcing portion protruding from a lower surface of the housing to support a rear surface of the terminal portion.

In another general aspect, an actuator includes a flexible printed circuit board on which a terminal portion for supplying power to a coil portion is formed, and a reinforcing portion for limiting deformation of the terminal portion of the flexible printed circuit board, and a camera module may include the actuator described above.

Other features and aspects will be apparent from the following detailed description, the drawings, and the claims.

### BRIEF DESCRIPTION OF DRAWINGS

FIG. 1 is an exploded perspective view of an example of an actuator;

FIG. 2 is a perspective view of the actuator illustrated in FIG. 1;

FIG. 3 is a perspective view illustrating a lower surface of the actuator illustrated in FIG. 2;

FIG. 4 is a diagram illustrating an example of a detailed structure of a flexible printed circuit board illustrated in FIG. 1; and

FIG. 5 is an exploded perspective view of an example of a camera module.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second element disposed above a first element based on the orientation of the device illustrated in the drawings also encompasses the device when the device is flipped upside down in use or operation,

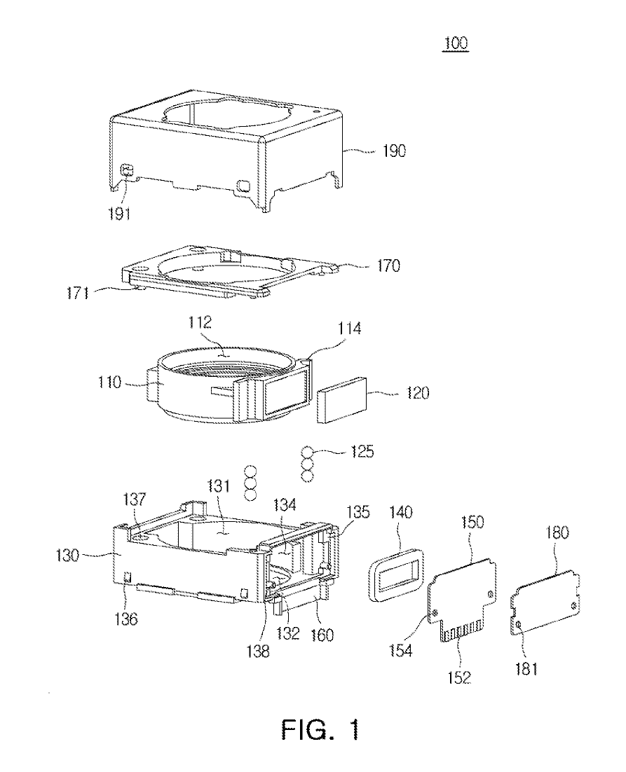

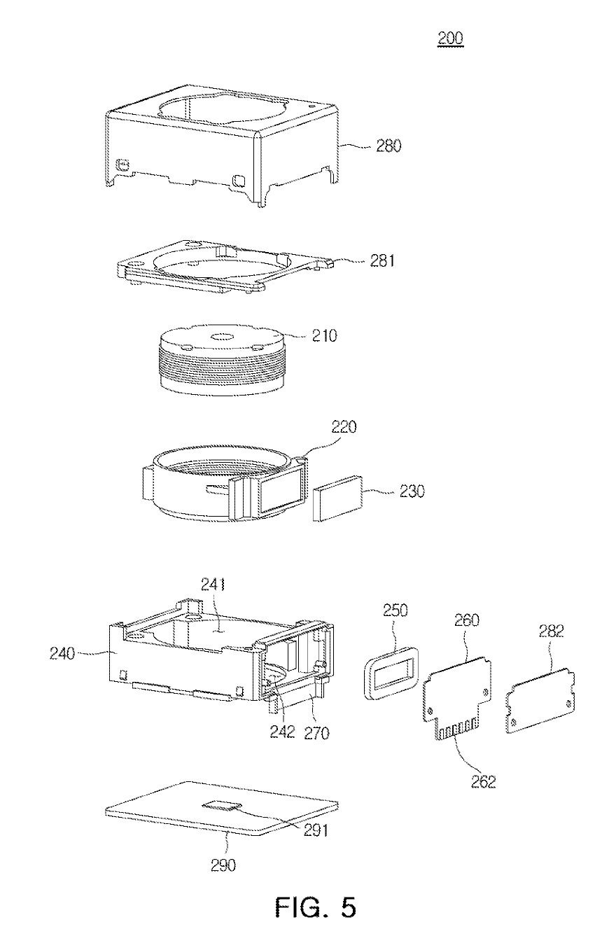

Referring to FIG. 1, the actuator 100 includes a carrier 110, a magnet 120, a housing 130, a coil portion 140, a flexible printed circuit board 150, and a reinforcing portion 160. The carrier 110 includes a hollow portion 112 to accommodate a lens portion 210 (see FIG. 5). The carrier 110 and the lens portion 210 move together along an optical-axis of the lens portion. Corresponding screw threads may be formed on an inner circumferential surface of the carrier 110 and an outer circumferential surface of the lens portion 210, respectively, and thus the lens portion may be screwed to the carrier 110. Alternatively, the lens portion may be inserted into and otherwise fixed to the hollow portion 112 formed in the carrier 110. In addition, the outer circumferential surface of the lens portion may be formed with a step, and the inner circumferential surface of the carrier 110 may be formed with a step corresponding to the outer circumferential surface of the lens portion so that the lens portion may be fixedly assembled with the carrier 110. As illustrated in FIG. 1, the inner circumferential surface of the carrier 110 may have a cylindrical shape, and an outer circumferential surface of the carrier 110 may have a cylindrical shape. However, the inner circumferential surface of the carrier 110 and the outer circumferential surface of the carrier 110 are not limited to this shape, and thus the outer circumferential surface of the carrier 110 may have a rectangular shape or may have a rectangular shape with four edges inclined with respect to two adjacent sides.

The magnet 120 is disposed on and fixed to the outer circumferential surface of the carrier 110. The magnet 120 generates a magnetic field to provide a driving force to drive the lens portion 210. The magnet 120 is configured to move in the optical-axis direction of the lens portion together with the carrier 110.

Although FIG. 1 illustrates the a single magnet 120 disposed on the outer circumferential surface of the carrier 110, a plurality of magnets 120 may be arranged at a plurality of outer circumferential surface areas of the carrier 110, respectively. In addition, an area of the outer circumferential surface on which the magnet 120 is disposed may be flat to increase a contact area with the magnet 120 to enhance coupling force. For instance, the carrier 110 includes a reinforcing member 114 formed on a portion of the outer circumferential surface of the carrier 110. The reinforcing member has a flat surface for receiving the magnet 120.

The housing 130 may include an open portion, or cavity, 131 to insert and accommodate the carrier 110, which holds the lens portion 210 and magnet, from an upper surface of the housing 130. For instance, the housing 130 has an inner space configured to accommodate the carrier 110 and the magnet 120. In addition, the open portion 131 corresponding to the carrier 110 formed in the upper surface of the housing 130 so that light is incident on the lens portion 210 within the carrier, and a lower open portion 132 is formed in a lower surface of the housing 130 so that light passing through the lens portion 210 reaches an image sensor 291 (refer to FIG. 5) to be described later.

The housing 130 is configured to allow the carrier 110, lens portion 210 and magnet 120 to move along the optical axis O, while lateral surfaces of the housing 130 support a partial lower surface of the carrier 110 and magnet 120.

For instance, the lower open portion 132 corresponding to the hollow portion 112 of the carrier 110 is formed in a portion of the lower surface of the housing 130, and a lower support surface extending toward an internal side of the housing 130 from an external side may be formed on the remaining region to support the carrier 110 and the magnet 120.

The coil portion 140 is disposed on a lateral surface of the housing 130 to face the magnet 120 accommodated in the inner space of the housing 130. For instance, the coil portion 140 may face the magnet 120 across the lateral surface of the housing 130. The magnet 120 may be disposed on an inner lateral surface of the housing 130, and the coil portion 140 may be disposed on an outer lateral surface of the housing 130. By disposing the magnet 120 adjacent to the coil portion 140, the coil portion 140 may be positioned along a magnetic field formed by the magnet 120. When power is supplied to the coil portion 140, the coil portion 140 generates a magnetic field that interacts with a magnetic field of the magnet 120 to generate a driving force for driving the carrier 110 and lens portion 210. Although FIG. 1 illustrates a single coil portion 140 disposed adjacent to a single magnet 120, a plurality of magnets 120 may be disposed on the outer circumferential surface areas of the carrier 110, respectively. A plurality of coil portions 140 may be arranged at the lateral surface of the housing 130 to respectively face each of the plurality magnets 120.

The flexible printed circuit board 150 includes a terminal portion 152 formed on one surface thereof to supply power to the coil portion 140. The coil portion 140 receives power to generate a driving force via a magnetic field interaction with the magnet 120. The flexible printed circuit board 150 may be connected to the coil portion 140 to supply power to and control the coil portion 140.

The flexible printed circuit board 150 may receive external power and transmit power to the coil portion 140 through the terminal portion 152 formed on a portion of one surface of the flexible printed circuit board 150. The coil portion 140 includes an electrode connection portion, extending from two ends of the coil portion 140, electrically connected to the flexible printed circuit board 150. In addition, the flexible printed circuit board 150 is coupled to the lateral surface of the housing 130 to expose the terminal portion 152 formed on one surface of the flexible printed circuit board 150 outwardly. As illustrated in FIG. 1, the coil portion 140 is disposed on and/or coupled to an external lateral surface of the housing 130, and the flexible printed circuit board 150 is coupled to the external lateral surface of the housing 130 to cover the coil portion 140 and to face the coil portion 140.

In this case, the flexible printed circuit board 150 is coupled to the housing 130 so that the terminal portion 152 is directed outwardly. The flexible printed circuit board 150 may be a two-sided flexible printed circuit board, the terminal portion 152 may be formed one surface of the flexible printed circuit board 150, and an electronic device may be mounted on the other surface. The flexible printed circuit board 150 is coupled to the housing 130 so that the other surface on which the electronic device is installed faces the external lateral surface of the housing 130.

As described above, by disposing the terminal portion 152, formed on the flexible printed circuit board 150, on an outer surface of the flexible printed circuit board, an external power supply and the terminal portion 152 may be easily coupled. In addition, a flexible printed circuit board is manufactured to be slim, in comparison to a rigid board, to reduce an overall size of an actuator, thereby achieving a more compact structure.

The reinforcing portion 160 protrudes from a lower surface of the housing 130 to support a rear surface of the terminal portion 152 to limit deformation of the terminal portion 152.

A region of the flexible printed circuit board 150, to which the housing 130 contacts and/or is coupled, is supported by the external lateral surface of the housing 130, however, a portion of the flexible printed circuit board 150, on which the terminal portion 152 is formed, does not contact the housing 130, and thus is not supported by the external lateral surface of the housing 130. Accordingly, the terminal portion 152 of the flexible printed circuit board 150 may be deformed by external force, and when such deformation stress is continuously applied or external force exceeding deformation resistance is applied, a circuit pattern disposed in the flexible printed circuit board 150 may be short-circuited.

In particular, when an image sensor to be described later and a printed circuit board 290 on which the image sensor is mounted (refer to FIG. 5) are not integrally assembled and are moved, the terminal portion 152 of the flexible printed circuit board 150 is always exposed, and thus may be easily damaged. Accordingly, the actuator 100 includes the reinforcing portion 160 disposed on the rear surface of the terminal portion 152 to limit deformation of the terminal portion 152. The reinforcing portion 160 contacts the rear surface of the terminal portion 152 or is spaced apart from the rear surface of the terminal portion 152 at a predetermined interval.

When the reinforcing portion 160 is spaced apart from the rear surface of the terminal portion 152, an interval at which the reinforcing portion 160 is spaced apart from the rear surface of the terminal portion 152 is within a range in which deformation of the terminal portion 152 is allowed. For instance, the flexible printed circuit board 150 allows for some degree of bending, and thus is formed in such a manner that the reinforcing portion 160 is disposed within a range in which such deformation is elastic.

The reinforcing portion 160 protrudes from a lower surface of the housing 130 and may be integrally formed with the housing 130, but the reinforcing portion 160 may alternatively be adhered to a lower surface of the housing 130 after being separately manufactured and formed from the housing 130.

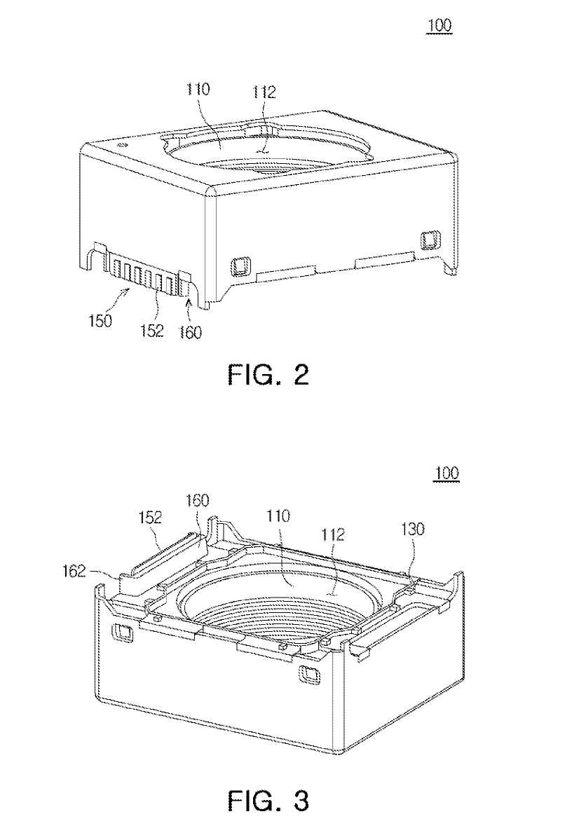

Referring to FIGS. 2 and 3, the reinforcing portion 160 further includes lateral protrusion portions 162 that respectively protrude from two ends of the reinforcing portion 160 to cover lateral surfaces of the terminal portion 152 as well as a rear surface of the terminal portion 152. As such, the reinforcing portion 160 covers the lateral surfaces of the terminal portion 152 to more stably support the terminal portion 152, and structural strength of each of the terminal portion 152 and the reinforcing portion 160 is further enhanced.

As illustrated in FIGS. 2 and 3, the terminal portion 152 of the flexible printed circuit board 150 is exposed to supply power to the coil portion. The reinforcing portion 160 may be formed on a rear surface of the terminal portion 152, thereby reinforcing structural strength of the terminal portion 152 without restriction of power supply of the terminal portion 152.

Referring to FIG. 3, the housing 130 may be coupled to the carrier 110 to cover an entire portion of a lower surface of the carrier 110 except for the hollow portion 112 of the carrier 110, for accommodation of the lens portion, thereby preventing impurities from being introduced to the actuator 100.

Referring back to FIG. 1, the housing 130 may include a lateral open portion 134 formed in a lateral surface of the housing 130, on which the magnet 120 is disposed, in order to expose the magnet 120 to the coil portion 140. For instance, the lateral open portion 134 corresponding to a shape of the magnet 120 may be formed in a lateral surface of the housing 130 which faces the magnet 120, among lateral surfaces of the housing 130.

The lateral open portion 134 is formed in one lateral surface of the housing 130 to more effectively generate driving force generated via interaction between the magnetic fields of the magnet 120 and the coil portion 140. In addition, an accommodation portion 135 is formed at one lateral surface of the housing 130 to stably accommodate and couple the flexible printed circuit board 150 to the housing 130.

In addition, guide balls, or bearings, 125 are disposed between the housing 130 and the carrier 110 to smoothly guide the carrier 110 with respect to the housing 130. The guide balls 125 are disposed between the housing 130 and the carrier 110, thereby preventing restriction of movement of the carrier 110 due friction between the housing 130 and the carrier 110.

As illustrated in FIG. 1, the actuator 100 further includes a shielding member 190, a stopper 170, and a yoke 180.

The shielding member 190 is coupled to the housing 130 to shield external electromagnetic influence and to cover lateral and upper surfaces of the housing 130 and the flexible printed circuit board 150. The shielding member 190 shields electromagnetic waves. The shielding member 190 may have a shape and size corresponding to the shape and size of the housing 130 and the flexible printed circuit board 150 and may be formed of a material, such as iron, that advantageously shields electromagnetic waves.

A coupling portion, or protrusion, 136 protrudes from a lateral portion of the housing 130 and a coupling groove 191 is disposed on the lateral side of the shielding member 190 to couple the shielding member 190 to the housing 130. The coupling groove 191 corresponds to the coupling portion 136 of the housing 130 so that the coupling portion 136 may be inserted into the coupling groove 191 to fix the shielding member 190 to the housing 130.

The flexible printed circuit board 150 may be coupled to a shielding member by coating an adhesive on one surface of the flexible printed circuit board 150 which faces the shielding member 190. When the shielding member 190 and the housing 130 are coupled to each other, one surface of the flexible printed circuit board 150, for instance, the surface on which the terminal portion 152 is formed is disposed to face the shielding member 190, and the other surface of the flexible printed circuit board 150 may be disposed to face the housing 130. In this case, the flexible printed circuit board 150 and the shielding member 190 are fixedly coupled to each other by coating an adhesive on one surface of the flexible printed circuit board 150 which faces the shielding member 190, and the adhesive surface between the flexible printed circuit board 150 and the shielding member 190 may be formed on a region above the terminal portion 152.

The stopper 170 is coupled to an upper surface of the housing 130 to support an upper surface of the carrier 110. The stopper 170 may be coupled to the housing 130 to prevent the carrier 110 from being separated from the housing 130 and to control movement displacement with which the lens portion moves in a direction along an optical-axis. In order to enhance coupling force between the housing 130 and the stopper 170, an insertion groove, or hole, 137 and an insertion portion 171 is formed between the housing 130 and the stopper 170, respectively. For instance, the insertion groove 137 may be recessed in an upper surface of the housing 130, and the insertion portion 171 may protrude from a lower surface of the stopper 170 at a location corresponding to the insertion groove 137 of the housing 130. Alternatively, an insertion portion may be formed on the upper surface of the housing 130, and an insertion groove may be formed in the lower surface of the stopper 170.

In addition, the stopper 170 coupled to the upper surface of the housing 130 may be formed of an elastic, or flexible, material to elastically support the upper surface of the carrier 110. In addition, the stopper 170 may apply a pressure to the carrier 110 to provide a downward force on the carrier 110.

The yoke 180 is disposed on an external lateral surface of the flexible printed circuit board 150 to control the amplitude and direction of magnetic flux generated by the magnet 120. The yoke 180 may be formed of a metallic material to enhance intensity of magnetic flux formed by the magnet 120 to effectively generate a driving force for driving the lens portion.

As illustrated in FIG. 1, the yoke 180 may be coupled to the housing 130, and, a through hole 181 is formed in the yoke 180 to receive a protrusion portion 138, formed on a lateral surface of the housing 130. In this case, a through hole 154 is also formed in the flexible printed circuit board 150 at a location corresponding to the lateral protrusion portion 138.

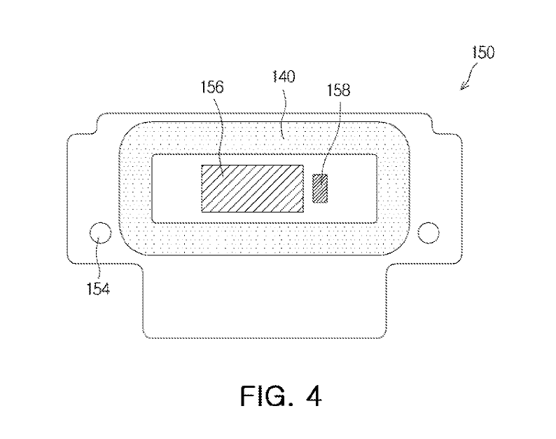

Referring to FIG. 4, the flexible printed circuit board 150 includes a drive integrated circuit (IC) 156 and a multilayer ceramic capacitor (MLCC) 158. The drive IC 156 is installed on one surface of the flexible printed circuit board 150 to control driving of the lens portion, and the MLCC 158 is installed on one surface of the flexible printed circuit board 150 to control a current applied to the coil portion 140. The drive IC 156 and the MLCC 158 are installed on a surface of the flexible printed circuit board 150 opposite the surface the terminal portion 152 is disposed on. The terminal portion 152 supplies power to the drive IC 156 and the MLCC 158. As illustrated in FIG. 4, the coil portion 140 is coupled to and disposed on one surface of the flexible printed circuit board 150, and as described above, the coil portion 140 is configured to electrically connect an electrode connection portion of the coil portion to the flexible printed circuit board 150 in order to receive power through a terminal portion 152 formed on the other surface of the flexible printed circuit board 150.

The drive IC 156 may include a location sensor to detect a location of a magnet, and the location sensor may be a hall sensor. The location sensor detects the location of the magnet, for instance, to determine a displacement of the lens portion in order for the camera module to precisely and rapidly control movement of the lens portion.

Referring to FIG. 5, the camera module 200 includes a lens portion 210, a carrier 220, a magnet 230, a housing 240, a coil portion 250, a flexible printed circuit board 260, a reinforcing portion 270, and a shielding member 280. With reference to FIGS. 1 through 4, a description of the aforementioned actuator has been described above.

At least one lens and a lens barrel is installed in the lens portion 210 of the camera module 200. The lens portion 210 includes a focus lens for auto focus and may include a single lens or a plurality of lenses. When the lens portion 210 includes a plurality of lenses, the plurality of lenses may be arranged to be stacked along an optical-axis direction. The lens portion 210 transmits light incident thereon. As illustrated in FIG. 5, a lens barrel for covering and accommodating a single lens or a plurality of lenses has a cylindrical shape.

As described above, a screw structure may be formed on an outer circumferential surface of the lens portion 210, and a screw structure may be formed on an inner circumferential surface of the carrier 220 to correspond to the screw structure formed on the outer circumferential surface of the lens portion 210, and thus the lens portion 210 may be screwed to the carrier 220.

The camera module 200 includes the housing 240. The housing 240 includes open portions 241 and 242 that expose upper and lower surfaces of the lens portion 210, respectively, allowing light to pass and to reach the lens portion 210. For instance, the open portion 242 may be formed in the upper surface of the housing 240 as well as the lower surface.

As illustrated in FIG. 5, the camera module 200 further includes the image sensor 291 and the printed circuit board 290. The image sensor 291 collects light transmitted through the lens portion 210 and convert the light into an electrical signal. The image sensor 291 is disposed below the housing 240 so that light transmitted through the lens portion 210 reaches the image sensor 291.

The printed circuit board 290 is coupled to the lower surface of the image sensor 291 through a terminal portion 262 of the flexible printed circuit board 260 to supply a required power or current to the image sensor 291. The terminal portion may output an electrical signal from the image sensor 291.

The image sensor 291 is mounted on the printed circuit board 290, the printed circuit board 290 is coupled to a lower surface of the housing 240 or the shielding member 280, and in this case, the printed circuit board 290 is configured not to interfere with the reinforcing portion 270 formed on the lower surface of the housing 240. The camera module 200 further includes an infrared filter disposed on an upper surface of the image sensor 291.

The camera module 200 further includes a stopper 281 that is coupled to an upper surface of the housing 240 to support the upper surface of the carrier 220, and a yoke 282 that is disposed on an external lateral surface of the flexible printed circuit board 260 to control the size and direction of magnetic flux formed by the magnet 230.

As set forth above, an actuator includes a flexible printed circuit board to supply power to a coil portion as one component of a driver for generating driving force required to drive the lens portion, separate from a printed circuit board on which an image sensor is mounted. A reinforcing portion is formed on a lower surface of a housing to protect a terminal portion formed on the flexible printed circuit board, thereby preventing internal short circuits of the flexible printed circuit board. As a result, driving reliability of the actuator may be ensured, and structural strength may be enhanced.

The camera module includes a flexible printed circuit board including a terminal portion and a reinforcing portion for protecting the terminal portion of the flexible printed circuit board, thereby easily coupling the terminal portion of the flexible printed circuit board and a printed circuit board on which an image sensor is mounted and stably maintaining the coupling.

As set forth above, with a camera module according to exemplary embodiments in the present disclosure, a terminal portion of a flexible PCB may be prevented from being damaged by having a simple structure, without a structural change of the flexible PCB.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

What is claimed is:

1. An actuator comprising:
a carrier accommodating a lens portion;
a magnet disposed on an outer circumferential surface of the carrier;
a housing comprising an opening formed in an upper surface of the housing wherein lateral surfaces of the carrier and the magnet are disposed within the housing;
a coil portion disposed on a lateral surface of the housing configured to face the magnet;
a flexible printed circuit board comprising a terminal portion, formed on one surface of the flexible printed circuit board, configured to supply power to the coil portion, wherein the flexible printed circuit board is coupled to the housing; and
a reinforcing portion protruding from a lower surface of the housing to support a rear surface of the terminal portion.

2. The actuator of claim 1, wherein the reinforcing portion further comprises lateral protrusion portions protruding from two ends of the reinforcing portion, respectively, to cover a lateral surface of the terminal portion.

3. The actuator of claim 1, wherein the housing comprises a lateral open portion formed in the lateral surface of the housing, wherein the magnet is disposed on the lateral open portion.

4. The actuator of claim 1, wherein the flexible printed circuit board comprises:
a drive integrated circuit (IC) installed on a surface of the flexible printed circuit board configured to control driving of the lens portion; and
a multilayer ceramic capacitor installed on a surface of the flexible printed circuit board configured to control current applied to the coil portion.

5. The actuator of claim 4, wherein the drive IC comprises a location sensor to detect a location of the magnet.

6. The actuator of claim 1, further comprising a shielding member coupled to the housing to shield external electromagnetic influence and to cover lateral and upper surfaces of the housing and the flexible printed circuit board.

7. The actuator of claim 6, wherein the flexible printed circuit board is coupled to the shielding member by an adhesive coating on one surface of the flexible printed circuit board facing the shielding member.

8. The actuator of claim 1, further comprising a stopper coupled to the upper surface of the housing to support an upper surface of the carrier.

9. The actuator of claim 1, further comprising a yoke disposed on an external lateral surface of the flexible printed circuit board configured to control a size and direction of magnetic flux formed by the magnet.

10. A camera module comprising:
a lens portion comprising a lens and a lens barrel;
a carrier, wherein the lens portion is disposed in the carrier;
a magnet disposed on an outer circumferential surface of the carrier;
a housing comprising open portions formed in upper and lower surfaces of the housing, respectively, to expose the lens portion, wherein lateral surfaces of the carrier and the magnet are disposed within the housing;
a coil portion disposed on a lateral surface of the housing corresponding to the magnet;
a flexible printed circuit board comprising a terminal portion, formed on one surface of the flexible printed circuit board and coupled to the housing, configured to supply power to the coil portion;
a reinforcing portion protruding from the lower surface of the housing to support a rear surface of the terminal portion; and
a shielding member covering lateral surfaces and upper surfaces of the housing and the flexible printed circuit board to shield external electromagnetic influence.

11. The camera module of claim 10, further comprising:
an image sensor, disposed below the housing, configured to collect light passing through the lens portion and convert the light into an electrical signal; and
a printed circuit board coupled to a lower surface of the image sensor.

12. The camera module of claim 10, wherein the reinforcing portion further comprises lateral protrusion portions protruding from two ends of the reinforcing portion, respectively, to cover lateral surfaces of the terminal portion.

13. The camera module of claim 10, wherein the flexible printed circuit board is coupled to the shielding member by coating an adhesive on one surface of the flexible printed circuit board facing the shielding member.

14. The camera module of claim 10, wherein the housing comprises a lateral open portion formed in the lateral surface of the housing on which the magnet is disposed.

15. The camera module of claim 10, wherein the flexible printed circuit board comprises:
a drive integrated circuit (IC) installed on one surface of the flexible printed circuit board configured to control driving of the lens portion; and
a multilayer ceramic capacitor installed on one surface of the flexible printed circuit board configured to control current applied to the coil portion.

16. The camera module of claim 15, wherein the drive IC comprises a location sensor to detect a location of the magnet.
